(19) United States
(12) Patent Application Publication
(10) Pub. No.: US 2003/0200140 A1
(43) Pub. Date: Oct. 23, 2003

(54) Secure method of and system for rewarding customer

(76) Inventor: Laszlo Hars, Cortlandt Manor, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/125,703

(22) Filed: Apr. 18, 2002

(51) Int. Cl. G06F 17/60

(52) U.S. Cl. 705/14

(57) ABSTRACT

A method of and system for granting points to a user for time spent in a locale is provided. The method includes the steps of: detecting time of entry of the user to the locale; transmitting at least one pseudo random bit stream to a portable device associated with the user, the bit stream being transmitted at a rate sufficient to prevent the bit stream from being recorded by the portable device; calculating a hash value for the bit stream transmitted to the portable device; detecting time of exit of the user from the locale; recording information in a memory of the portable device, the recorded information including at least the calculated hash value, the time of entry and the time of exit; storing data in a database associated with the locale, the stored data including enough information to re-generate the bit stream at any time interval and the number of customers in the locale at any time; verifying time of the user at the locale by comparing the stored information and the recorded data; and granting points for the user based on the verified time at the locale.

### FIELD OF THE INVENTION

The present invention relates to methods and systems for rewarding customers with credits, including both positive and negative credits, and more particularly, to security methods and systems for preventing fraud in such rewarding systems.

### BACKGROUND OF THE INVENTION

Business transactions, that is, the buying and selling of goods and services, have a long history characterized by continuing efforts and developments to facilitate the presentation and the knowledge of goods and services to prospective buyers. A goal of such efforts is to attract potential customers and make their shopping experience more comfortable and more productive.

After managing to attract visitors, a seller generally desires to keep the potential customer around as long as possible. Customers generally will only buy when they are in a store; therefore, it makes sense to keep them in the store as long as possible. It is also important to give customers a reason to return—preferably sooner rather than later. This may be achieved through various rewards programs.

In a virtual shopping environment, such as the Internet, for example, rewards programs involve rewarding the user in some way for using the site. The reward may be some type of cash payment, but more usually takes the form of points, or coupons which can be redeemed for goods or services. The rewards may be given out for simply visiting the site, performing some action on the site (buying something or signing up for a newsletter for example), or distributed directly to customers as a promotional tool to bring them to the site.

There are two main types of rewards schemes available on the Internet which may appeal to small and medium sized businesses: currency and coupons. Currency-based schemes are where points or tokens are “earned” and can later be “spent” at any other store participating in the scheme. Coupons typically require customers to register with a store, or network of stores and in return they will be sent discounts and special promotional deals. Coupons, loyalty schemes, discount cards, air miles and the like are tried and tested techniques for “bricks and mortar” stores and there is a wide use of these techniques on the Internet.

Whether it is a virtual store or a physical shopping mall, customer loyalty or “stickiness” is an essential requirement of a successful business. Although the quality of goods and services may be sufficient, in the ultra-competitive world of selling goods, successful stores, especially in the early stages, need an edge over the competition. The “theme” of the community that a store aims to build need not necessarily be an exact match to the products or services the store is trying to sell. The goal is to produce a niche where there will be a market for the products—but where the store will be the only player in town.

Therefore, there is a need for a method of creating and maintaining a certain level of customer retention in a physical store. That is, there is a need for improved methods of attracting individuals to a locale and physically retaining them in the locale. While most companies direct their advertising and promotional campaigns towards a product or brand, there is a potential in a marketplace for a method of attracting and retaining a specific market or customer segment. The objective is not only to attract new customers, but also to help retain existing customers.

Moreover, in some circumstances it is individuals who are gaining benefit from being in a locale and in such circumstances there is a desire to charge individuals for their presence in the locale. Existing systems, using turnstiles, ticket offices and the like, are often inconvenient and require large numbers of ticketing staff. At peak periods, long queues for tickets can develop. Accordingly, there is also a need for an improved means of charging individuals for their presence in a locale.

A traditional marketplace, just like an electronic marketplace, must support the basic process of commerce, where offers to buy or sell are made, offers are accepted, and considerations are paid. A viable marketplace must also address issues such as security and privacy, otherwise even if the basic process works, consumers and providers will not participate in the marketplace.

Information security is a necessity for electronic business and electronic commerce applications. Today, security services rely on the use of strong cryptographic mechanisms, which in turn often make use of random numbers.

Random number generation is used in a wide variety of cryptographic operations, such as key generation and challenge/response protocols. A random number generator is a device that outputs a sequence of 0s and is such that at any point, the next bit cannot be predicted based on the previous bits. However, true random number generation is difficult to do on a computer, since computers are deterministic devices. Thus, if the same random generator is run twice, identical results are received. True random number generators are in use, but they can be difficult to build. They typically take input from something in the physical world, such as the rate of neutron emission from a radioactive substance or a user's mouse movements. Because of these difficulties, random number generation on a computer is usually only pseudo-random number generation. A pseudo-random number generator produces a sequence of bits that has a random looking distribution. With each different seed (a typically random stream of bits used to generate a usually longer pseudo-random stream), the pseudo-random generator generates a different pseudo-random sequence. The level of randomness of the sequence depends on the level of randomness of the seeds. There are two common approaches to producing seed material for computers: One is based on a specialized hardware-based Random number generator. The other uses standard hardware such as a keyboard or mouse.

Another commonly utilized cryptographic concept is a hash function. Hash is a classic computer operation which forms a fixed-size result from an arbitrary amount of data. Ideally, even the smallest change to the input data will change about half of the bits in the result. Hash is often used for table look-up, so that very similar language terms or phrases will be well-distributed throughout the table.

A hash of data will produce a particular hash value, which then can be included in the message before it is sent (or stored). When the data are received (or read) and the hash value computed, this should match the included hash value. Therefore, if the hash is different, something has changed, and the usual solution is to request the data be sent again. However, the hash value is typically much smaller than the data, so there may be “many” different data sets which will produce that same value. This means that “error detection” inherently cannot detect all possible errors, and this is quite independent of any “linearity” in the hash computation.

An excellent example of a hash function is a CRC (Cyclic Redundancy Check) operation, which is a fast error-check hash based on mod 2 polynomial operations. CRC is a linear function without cryptographic strength, but it does have a strong mathematical basis which is lacking in ad hoc methods. Strength is defined as the ability of a cryptographic system to resist attack and maintain secrecy. Strength is typically necessary when keys are processed into the state used in a random number generator, because if either the key or the state becomes known, the keyed cipher has been broken. Similarly, a cryptographic hash function must be strong in the sense that it must be computationally infeasible to find two input values which produce the same hash result.

As such there is a need for a secure system and method for crediting customers for time spent in a locale, with credit including both positive and negative credits.

### SUMMARY OF THE INVENTION

According to a first aspect of the invention, there is provided a reward method including the steps of communicating between a beacon and a mobile device to determine whether the mobile device is within a predetermined locale; and crediting the mobile device to reward the user of the mobile device for presence within that locale.

The mobile device may be credited with an amount depending on the length of time the mobile device is within the predetermined locale to reward the user of the mobile device for continued presence within that locale. In this way it is possible to reward users of mobile devices for visiting a locale, thereby providing an incentive for those customers to remain within the locale. This can increase the chances of the customers making a purchase and also increase brand loyalty and awareness.

Alternatively or additionally, the mobile device may be credited for simple presence within a locale, for example at a specified time. This might be useful in store promotions, or to reward workers for remaining late, for example.

The mobile device may be credited with an electronic coupon exchangeable for goods and services when the mobile device is within the predetermined locale.

Alternatively or additionally, an account corresponding to the user of the mobile device may be credited with an amount when the mobile device is within the predetermined locale to reward the user of the mobile device for presence within that locale.

The credit may correspond to a wide variety of rewards. For example, the credit may be points on a loyalty card account of the user, reduced for product or services provided, or credits to the user's bank account. One example would be for a retailer to agree with a cellular phone operator to give five minutes free call time credit for 30 minutes of physical presence in the retailer's store. It is not necessary for the account to be in the name of the user; it may be desired to credit the user's company, family, charity or any other group or organization associated with the user with rewards.

In a way, the invention can be viewed as broadcasting a virtual currency to beneficiaries, who may be anonymous, in a particular space or locale. The locale may be the goal of a maze, a TV show, a family living room, a pop concert stadium, a theme park or even a place of work; the skilled person will readily think of other applications.

For example, workers may be credited for time on the job, for example overtime. Workers may carry a simple radio frequency badge, capable of Bluetooth networking with local beacons and divulging the badge's unique RF device I.D. Overtime could then be automatically rewarded for time spent in a particular job area, obviating any need for manual badge presentation/swipes by the worker.

The invention may use a fine-grained location technique to fix the location of a mobile device to within a few meters or tens of meters; such services are becoming more and more widely available. Suitable systems may include Global Positioning Service (GPS), Bluetooth, infra-red Data Access (irDA), RFLite, 802.11 or the use of network cellular triangulation methods. These techniques are expected to become commonplace, partially driven by regulations to assist emergency services, (e.g. the USA's E911 requirement), while high market penetration is predicted for Bluetooth technology in mobile phones.

The beacon may be a directional radio frequency beacon, for example broadcasting in a beam, to confine the credits to mobile devices within the beam.

As will be appreciated, mobile phones is one example of a mobile device that may be used in accordance with the invention, although other mobile devices such as Personal Digital Assistants (PDA's) would be suitable for use with the invention.

The method may include selectively crediting only to a sub-group of mobile devices. For example, the criteria for the selected sub-group may include the user's age, membership of an organization or a social group, the make of the handset, the user's network service provider or other criteria.

The selective crediting may include only making a connection to the selected mobile devices, providing a decryption key on the handset so that only handsets with the key can read the broadcast information stream. Alternatively, suitability for credit may be checked in the verification system.

For security, a one way hashing scheme may be employed on the mobile device.

The method may include broadcasting, from at least one beacon, signals that can be received within the predetermined locale; receiving the signals broadcast by the at least one beacon on a mobile device when the mobile device is within the locale; sending an identification signal from the mobile device to a verification system; determining in the verification system the length of time that the mobile device remains within range of the at least one beacon; and crediting the user of the mobile device identified by the identification signal.

By using the capability of a mobile device to pick up signals within range of a beacon, a retailer or other vendor, service provider etc. may provide at least one beacon in a locale and use the capability to pick up signals from that beacon as a convenient measure of presence within the locale.

The identification signal sent by the mobile device may be a Bluetooth device I.D. of the mobile device.

The communications may be handled in a number of ways. A first approach is for the mobile device to make a connection with the beacon when within range; the beacon can then receive the identification signal from the mobile device through the connection and pass the identification signal to the verification system to accumulate credits in an account corresponding to the identified mobile device depending on the time that the mobile device is in two-way connection with the beacon.

This approach is reasonably simple to operate and does not require special software on the mobile device. All that it requires is for two-way communication to be set up between a beacon and the mobile device and for the beacon to determine the identity of the mobile device from an identification signal issued by the mobile device. Local communications systems such as Bluetooth include protocols for setting up such two-way communication. The beacon can then pass on to the verification system details of the mobile device and how long the mobile device remains within range to determine in a simple manner the length of time that the mobile device remains within the locale.

The beacon may periodically poll the mobile device to determine whether the mobile device is within range.

In a second approach, the method may include the steps of broadcasting identification data sequences from the beacon; storing in the mobile device information based on the broadcast data sequences; presenting the recorded information for validation to determine the length of time the mobile device remains within the vicinity of the beacon; and crediting the mobile device with credit.

This approach has a number of advantages.

Firstly, it is not necessary to set up two-way communication between the beacon and the mobile devices to record the time spent by the mobile device within the locale so the finite number of two-way channels offered by local communication systems do not constitute a limit.

Secondly, power is saved since the mobile devices do not need to establish a connection with the beacon.

Thirdly, delays while setting up a connection can be avoided.

Fourthly, it is not necessary to disclose the user's identity to the system, thus preserving the anonymity and privacy of the user. Instead, the user can select when to present the recorded information for validation.

For still further increased privacy, the mobile device may transmit the recorded data signal to an intermediary for determining the length of time that the user is within a locale and crediting the account. The intermediary may be a trusted third party such as the mobile phone company rather than the operator of the locale. Details of the amount credited to the account may then be made available to the operator of the locale while keeping the user's details such as his Bluetooth identification secret.

The beacon may broadcast periodically a data set comprising an identification number that varies with each broadcast. These can be recorded in the mobile device by accumulation in a register. This may be done, for example, by simple addition of each received identification number to the register, or by adding and subtracting the received identification numbers alternately to create a verifiable record. The result of the accumulation of the identification numbers can then be checked on validation to determine the length of time the mobile device remained within the vicinity of the beacon.

The identification number may be a pseudo-random number.

The data set periodically broadcast by the beacon may include a locale signature indicating the locale, the time and/or a sequence number that increments with each successive broadcast to identify the specific broadcast received.

In order to incorporate the data set into the Bluetooth protocol the data set broadcast by the beacon may be embedded in the inquiry phase of a Bluetooth message signal.

In another aspect, the invention relates to a system for crediting accounts of users of mobile devices, comprising

a beacon for transmitting signals to be received by mobile devices within range of the beacon; and

a verification system for receiving a signal from a mobile device, identifying the mobile device, determining the length of time that the mobile device spends within range of the beacon and crediting a user account corresponding to the mobile device with a credit corresponding to the length of time spent within range.

The beacon may be a Bluetooth beacon. A plurality of beacons may be provided to provide coverage over the whole of a locale.

In embodiments the beacon may contain a transceiver for establishing two-way communication with a mobile device within range and thereby receiving identification information identifying the mobile device, the verification system may include a data storage device for recording the credit in user accounts; and the transceiver may be connected to the verification system to pass the identification information to the verification system so that the user account corresponding to the mobile device can be identified and credited. Such a system can operate the invention using the first approach described above and accordingly obviate any requirement for special software or programming of the mobile devices.

In alternative embodiments the at least one beacon transmits identification data sets for recordal by the mobile device. The verification system may be arranged to receive a separate verification signal initiated by the mobile device and to validate the verification signal against the transmitted identification data sets to determine the length of time that the mobile device remains within range of the at least one beacon.

Such a system allows the operation of the second approach described above.

In another aspect there is provided a mobile device for use in a reward system, including a transceiver for receiving local transmitted signals containing identification information when the mobile device is located in a locale containing a beacon transmitting the signals; a memory; and code for carrying out the steps of recording in the memory information based on the broadcast identification data sets and causing the mobile device to transmit the recorded information to a verification system so that the length of time the mobile device remains within the vicinity of the beacon can be determined and the user of the mobile phone rewarded for remaining in the locale.

The mobile device may be, for example, a mobile phone, a PDA or an employee badge.

Such a mobile device may allow its user to accumulate credits in the second approach described above.

The transmission actuator may be under direct user control, for example, the user may select a menu option to transmit stored details for verification. Alternatively, the transmission actuator may be programmed into the mobile device to trigger transmission of stored data, for example on receipt of a request received on the mobile device from a verification computer.

The transceiver may be a Bluetooth transceiver.

The code may cause the mobile device to accumulate the broadcast identification numbers in a register in the memory of the mobile device and transmit the contents of the register for verification to determine the length of time the mobile device remained within the vicinity of the beacon. In this way, the mobile device may be adapted for use with a beacon that broadcasts a sequence of data sets, each data set including an identification number that varies with each broadcast data set.

The mobile device may be arranged to transmit the stored details to a verification system through a mobile telephony transceiver separate from the transceiver used for receiving local signals.

The invention is not limited to reward systems, i.e. with positive credit, but can be extended to charging or debit systems also. Accordingly, in a yet further aspect, the invention relates to a method of crediting or debiting a mobile device including the steps of communicating between a beacon and a mobile device to determine whether the mobile device is within a predetermined locale; and crediting or debiting the mobile device to reward or charge the user of the mobile device for presence within that locale.

The method may include any or all of the features discussed above with reference to reward systems. In particular, the connection may be a Bluetooth connection.

The method may include the steps of broadcasting, from at least one beacon, signals that can be received within the predetermined locale; establishing a connection between a beacon and a mobile device when a mobile device is within a predetermined locale; receiving at the beacon an identification signal from the mobile device through the connection; crediting or debiting the mobile device corresponding to the identification system to charge the user of the mobile device for presence within that locale.

The method may credit or debit the mobile device with an amount depending on the length of time the mobile device is within the predetermined locale to reward or charge the user of the mobile device for continued presence within that locale.

The mobile device may be debited if the mobile device is within the predetermined locale within a predetermined time interval.

In yet another aspect, a method of granting points to a user for time in a locale is provided. The method includes the steps of: detecting time of entry of the user to the locale; transmitting at least one pseudo random bit stream to a portable device associated with the user, the bit stream being transmitted at a rate sufficient to prevent the bit stream from being recorded by the portable device; calculating a hash value for the bit stream transmitted to the portable device; detecting time of exit of the user from the locale; recording information in a memory of the portable device, the recorded information including at least the calculated hash value, the time of entry and the time of exit; storing data in a database associated with the locale, the stored data including enough information to re-generate the bit stream at any time interval and the number of customers in the locale at any time; verifying time of the user at the locale by comparing the stored information and the recorded data; and granting points for the user based on the verified time at the locale.

The hash function for calculating the hash values of the bit stream can be an iterated function.

In another aspect, a system of granting points to a user for time in a locale is provided. The system includes: a portable device associated with the user, the portable device having a calculator for calculating a hash value of a bit stream, and a memory for recording information; and a verification system for verifying time of the user at the locale. The verification system includes means for verifying requested time of entry of the user to the locale and time of exit of the user from the locale, a source for transmitting at least one pseudo random bit stream to the portable device, the bit stream being transmitted at a rate sufficient to prevent the bit stream from being recorded by the portable device, a calculator for calculating the hash value of the bit stream, a database for storing data, such as random number generator seeds and their activation time, which allows the calculation of data including at least the hash value of the bit stream between any time of entry and time of exit, means for comparing the generated values based on the stored data from the database and the recorded information from the portable device, wherein the recorded information includes at least the calculated hash value, the time of entry and the time of exit, to verify time of the user at the locale, and means for granting points to the user based on the verified time at the locale.

The above, as well as further features of the invention and advantages thereof, will be apparent in the following detailed description of certain advantageous embodiments which is to be read in connection with the accompanying drawings forming a part hereof, and wherein corresponding parts and components are identified by the same reference numerals in the several views of the drawings.

### BRIEF DESCRIPTION OF THE DRAWINGS

Embodiments of the invention will now be described by way of example with reference to the following figures in which:

FIG. 1 shows a schematic diagram of a first embodiment of a system according to the present invention;

FIG. 2 shows a flow diagram of a method of crediting an account using the system of FIG. 1;

FIG. 3 shows a schematic diagram of a system according to a second embodiment of the present invention;

FIG. 4 shows a schematic diagram of a system according to a third embodiment of the present invention;

FIG. 5 shows a detailed schematic diagram of a mobile device for use with the present invention;

FIG. 6 illustrates a Bluetooth inquiry hopping sequence;

FIG. 7 illustrates additional data appended to an ID packet;

FIG. 8 illustrates data being interspersed with a clock;

FIG. 9 illustrates an alternate way for data to be interspersed with the clock;

FIG. 10 is a flow diagram of the processing carried out in the mobile device used in the third embodiment of the present invention;

FIG. 11 is a flow diagram illustrating a method according to a fourth embodiment of the present invention; and

FIG. 12 is a flow diagram illustrating a validation procedure according to the fourth embodiment of the present invention.

### DETAILED DESCRIPTION OF THE PREFERRED EMBODIMENT(S)

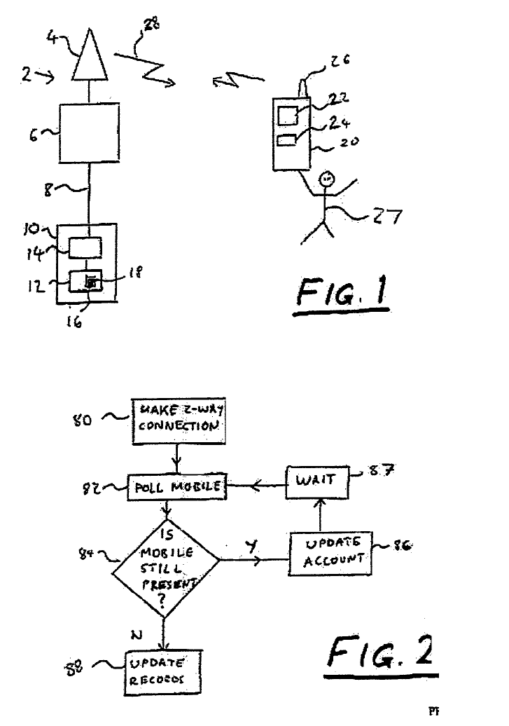

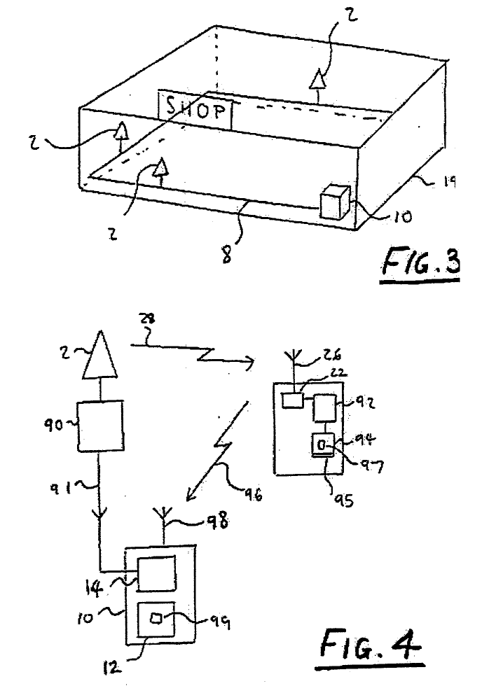

A first embodiment will be described with reference to FIGS. 1 and 2. A beacon 2 comprises an aerial 4 and a data processor 6 for sending and receiving data sequences, as is known. The beacon 2 is connected through a local network 8 to a verification terminal 10. The verification terminal 10 is implemented in a computer system having a data store 12 and a processor unit 14. The data store 12 may be a memory chip, a hard disc drive, or any of the many data storage devices suitable for storing data. Part of the data store 12 contains a database 16 containing a list of accounts 18, a mobile telephone identification number corresponding to each of the accounts and a credit associated with each account. As will be appreciated, the database 16 may also contain additional information such as the user's address, shopping habits, and any other information that may be available, subject to considerations of cost, privacy and utility.

A mobile telephone suitable for use in the first embodiment is simply a conventional mobile telephone 20 fitted with a transceiver 22. The mobile telephone includes a unique I.D. (Identification) number 24, stored for example in ROM or EPROM, identifying the mobile telephone.

FIG. 2 illustrates the steps of a method according to the invention, and using the system of FIG. 1.

On arrival in the locale the mobile phone 20 comes within range of the beacon. The system then connects (step 80) the beacon to the mobile phone.

A particularly suitable standard for the beacon 2 and the transceiver 22 is the Bluetooth standard, largely because it is expected to be widely adopted in future mobile devices. The connection (step 80) can accordingly occur by joining the mobile phone to an active Bluetooth piconet according to Bluetooth protocols. The Bluetooth connection is shown schematically at 28 in FIG. 1.

Since the Bluetooth standard allows only eight mobile devices in the piconet, only eight users can accumulate credit at a time. As an alternative, the mobile phone can be put into a Bluetooth “parked” state which can accommodate 254 devices. A further possibility is to place the mobile device's identity on a stack of recognised devices. Each of the devices in the stack can regularly be sent a “page” command for requesting mobile device acknowledgements while the device remains in the locale.

Further details of Bluetooth are provided later.

After connection is established, the beacon polls (step 82) the mobile device with its unique device identifier to check (step 84) that the mobile device is still within the locale. If so, the account of the user corresponding to the device identifier is credited (step 86) with an amount corresponding to a further minute of time spent within the locale. Then, the system waits (step 87) before polling the mobile device again (step 82) so that the mobile device is polled periodically, for example once per minute.

If the user has left the locale, the length of time the user spent within the locale may be determined and the account adjusted (step 88) depending on this final length of time. For example, the user account may be credited with a bonus if the user remains within the locale for more than half an hour.

As an alternative, the time that the user remains in the locale can be retained in a short term memory and the account information only updated when the user leaves the locale.

A further alternative is not to credit any kind of account, but instead to transfer an electronic coupon to the mobile device wherein the electronic coupon is exchangeable for goods, services, or a combination of goods and services. Indeed, the coupon may be exchangeable for any kind of reward.

Instead of a positive credit, a negative credit or debit may be applied to the account to charge the user for visiting and/or remaining in the locale.

The user can apply for a reward during or after their visit to the locale. For example, the user can present their device's short-range network I.D., for example a Bluetooth device I.D., as the authentication for receiving credits against their phone's I.D.

Authentication of a user's request for a reward can be done by means of a cross-check of the mobile phone number and the Bluetooth device identifier. The database records credit against the Bluetooth device identifier recorded by the beacon. By agreement with the network operator, the operator of the reward system may be able to credit the user's telephone account directly.

Further verification is possible, if required, using unique device keys, hash signatures, or other methods.

The system shown in FIG. 1 uses only a single beacon. FIG. 3 illustrates a second embodiment in which a plurality of Bluetooth beacons 2 are provided within a locale 19, all connected to a single verification system 10 through a local area network (LAN) 8. In this way, a greater number of users can be connected to a beacon simultaneously and the placing of the beacons can be arranged to provide good coverage throughout the locale.

It is not necessary for each beacon to have the same functionality. For example, some fixed beacons can be dedicated to discovering valid mobile device I.D.s while others can perform the polling of the devices. To achieve this, the inquirer beacon or beacons would establish the presence of the user's mobile device on entry to the locale. The other beacons would in parallel perform the regular polling to ensure that the user remains in the locale.

While base stations or beacons will typically be independent of one another (in a shopping mall set up, each shop provides and maintains its own beacon without reference to any beacons provided by neighboring shops), the beacons may be wholly or partially networked with at least some coordination as to their broadcast messages.

The skilled person will realize that a number of alternative possibilities are available. For example, the user's mobile device may be registered by a short-range transceiver at the entry to a locale and a separate short-range transceiver may be provided at the exit to register the user's departure.

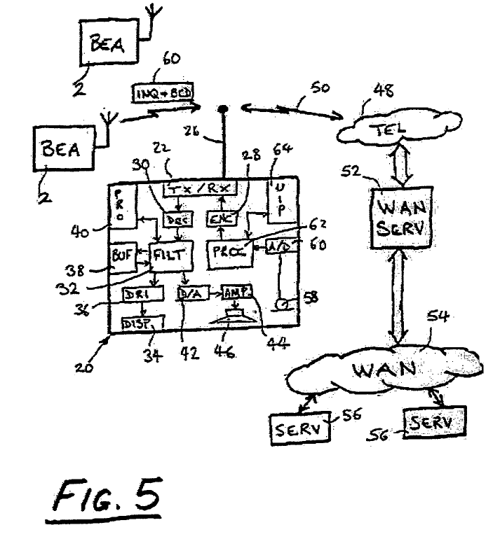

A third embodiment of the invention will now be described with reference to FIG. 4. In this approach, the beacon 2 is connected to a data sequence generator 90 for generating identification sequences. The generator is a conventional computer having a processor and a memory, the memory containing software for causing the computer to output data sequences or the generator may be another device with similar functionality.

The data sequence generator 90 outputs data sets at a rate of at least a few megabits per second. Each transmitted piece of data includes a pseudo-random number rᵢ among other information.

The pseudo-random number is generated from a secret starting seed, which is reset regularly, for example every day or hour. The computer records the pseudo-random number generator seeds and the corresponding time and date. The skilled person will readily appreciate how to generate such pseudo random sequences in well-known ways.

The data set may be embedded in a Bluetooth inquiry scan as will be explained later.

The broadcast data is received by a mobile device 20 when the mobile device is in range. The mobile contains a processing unit 92 and a memory 94 containing code for recording the received data. The code may be pre-installed or may be downloaded from the beacon.

The processing of the software in the mobile device will be explained with reference to the flowchart of FIG. 10. Firstly, the software causes the mobile device to receive information from the beacon and to recognize the type of data received (step 101). If data needs to be extracted, for example if the data is embedded in a Bluetooth inquiry scan, the data transmitted by the beacon is then extracted (step 103). The program then stores (step 105) the locale identifier ID the first time it encounters a broadcast, together with the time of the broadcast ti and the pseudo-random number as transmitted: {t₁, r₁, ID}. The checksum S, which is stored in the memory of the mobile device, is initialized with the first pseudo-random number r₁ (step 107).

As data continues to be received (step 109) the program accumulates (step 113) the received random numbers in a register 95 in the memory 94, for example by simple addition (discarding overflow above the length of the accumulator) of each received number with the number already in the register 95, or by alternate addition and subtraction of received numbers to create a verifiable checksum as is known from standard computer data transactions. However, a secure hash function of the received numbers is preferable for security reasons. This avoids having to store long sequences of data in the event that the data is received for long periods.

If no data is received for more than a predetermined period, the program then stores the data set indicative of the sequence received (step 115) including the time of the last received pseudo random number and the final value of the hash function prior to any interruption of the continuous consecutive sequence: {t_{f}, S_{f}}.

The mobile now has the following data from one sequence stored:

[ID, {t₁, r₁}, {t_{f}, S_{f}}].

The storage of r₁ is not necessary; it only helps to synchronize the clocks of the mobile device and of the shop.

Several such sequence records may be stored on the mobile device when receptions of broadcasts are interrupted, or for successive visits to one or more locales.

At some later time, the transmission of the sequence data can be triggered (step 117) either by the user, for example by menu selection on the mobile device, or on receipt of a suitable trigger message by the mobile device.

The sequence records are then transmitted (step 119) to a verification computer for validation. In the embodiment, the sequence records are transmitted via a cellular signal 96 to an aerial 98, part of the cell phone network, connected to a verification computer 10.

The verification computer 10 is also passed information about the transmitted data sets from the sequence generator 90 through a network connection 91. The skilled person will appreciate that there are many ways of linking the sequence generator 90 to the verification computer 10, such as, purely by way of example, through a leased line, the Internet, or through the cellular network.

The verification computer 10 contains code 99 for comparing the sequence records transmitted by the mobile against the data originally broadcast (step 121) and updating the user's account if the sequence records match (step 123).

A number of steps may be taken to prevent fraud. For example, submission of identical sequence records from several applicants may be disallowed to avoid sequence records being copied from one user's mobile device to another. The sequence records may also be checked against reasonable limits of dwell times.

Another approach includes using one-way hashing on the mobile. This may be done immediately on reception of the broadcast sequences in the mobile device to avoid the risk of copying the credit sequence and resulting false claims for reward sequences copied onto other mobiles.

For this, the accumulator is initialized with the first incoming broadcast number r₁ is combined with a unique mobile device identifier or PIN k, such as its Bluetooth device I.D., by a one-way hash function h (r,k). Such one-way functions are well known in the art. The device key k must then be presented for validation together with the hashed number or numbers or some function of the hashed number or numbers.

The algorithm for hashing may be an integral part of the receiving device's radio unit. To avoid tampering with the unit, tampering may disable the radio unit.

Other security schemes that may be used include public and private encryption keys, or a digital watermark embedded in the broadcast sequence.

This embodiment offers several advantages for protecting privacy against systems which the users do not trust tracking their movements and the places they frequent. One is that the user only identifies himself at the time that the sequence record is presented for reward; at that time the user may or may not be required to disclose some personal data, such as a phone or bank account to receive the award. Also, the validation computer can be owned by a trusted third party. The third party may have contractual arrangements with a number of locales. Moreover, the absolute time that users are present in the locale may not be needed.

The skilled person will appreciate that the sequence records can be presented by the mobile device to the validation computer in any of a number of ways. For example, instead of the transmission of this data through the cellular network an internet connection or a local Bluetooth connection might be used. Electric connection is also possible as printed paper, verbal communication or any other means of information transfer.

The approach carries the advantage of avoiding any “Big Brother” concerns of users being monitored by the locale's system. For example, the cellular network operator may act as a trusted intermediary in performing the validation operation, using a history file of recent sequence broadcasts supplied by the locale's operator, and then after validation the user's network phone account can be credited. The network operator is known to and already trusted by the user, and may be more trusted and trustworthy than the operator of a locale, such as a new department store. In any event, the network operator will already have to be aware to a limited extent of the user's movements, for example for emergency purposes.

Although at first sight the above approach may not appear suitable for debit systems that charge the user to visit or remain in a particular locale, the approach can be adapted for use in such systems by automatically and periodically establishing a link between the mobile device and the verification computer. It is, of course, necessary to ensure that the user cannot delete stored sequences when these represent costs charged to the user; for this reason it may be necessary to store the sequences in non-volatile memory, on a flash memory or the like.

Any of these embodiments could be incorporated in other systems. For example, an electronic wallet installed on the mobile device may be used to improve the efficiency or security of the validation or reward processes. Also, a mobile portal on the mobile device may mediate in making the crediting of the user's accounts as automatic as possible. The portal may keep records of who the user trusts, which accounts are to be credited, their preferred type of reward etc.

Rather than record credit in an account, an electronic coupon may be transmitted to the mobile device. This may be linked to other content, such as MP3 audio, pictures or video that is simultaneously broadcast. Such content might be promotional material or advertisements.

This link may be implicit or explicit. For example, the credit data sequence may be embedded via the use of known techniques of digital watermarking, in an accompanying content. The techniques used in digital watermarking to prevent illegal content copying can also be applied to prevent re-copying of the crediting data sequence which was broadcast. Alternatively, means may be provided on the mobile device to store and forward the content material and its linked credits onto other mobile devices, for example so that other consumers can use the coupons or credits. The coupon can thus act as an incentive for so-called “viral marketing” or “pyramid selling” promotional schemes. The first recipient may continue to accumulate further credits over time as the original captured broadcast sequence continues to spread out to other consumers.

Details of how information may transmitted will now be provided with reference to FIGS. 5 to 9. Much of this information is presented in more detail in copending commonly assigned prior patent applications GB0015454.2 filed Jun. 26, 2000, GB0020099.8 filed Aug. 15, 2000, GB0015452.6 filed Jun. 26, 2000 and GB0020101.2 filed Aug. 15, 2000, the contents of which are incorporated herein by reference.

In general terms, the user's device 20 comprises an aerial 26 coupled with transceiver stage 22 for the reception and transmission of messages. Messages received via the aerial 26 and transceiver 22 are passed via a decoding stage 30 to a filtering and signal processing stage 32. If the data carried by the message is for presentation on a display screen 34 of the telephone, the data will be passed to a display driver 36, optionally after buffering 38, with the driver formatting the display image. As will be recognized, the display 34 may be a relatively simple low-resolution device, and the conversion of received data to display data may be carried out as a subset of the processing stage 32 functionality, without the requirement for a dedicated display driver stage.

The mobile device 20 has the ability to filter incoming messages. Where the message is carrying data from one or other of the beacons 2 for display on a screen, the telephone has the ability to filter the information received according to pre-stored 40 user preferences and the user is only alerted (i.e. the information will only be retained in buffer 38 and/or presented on screen 34) if comparison of stored preference data and subject matter indicators in the message indicate that an item of data of particular interest has been received.

For conventional audio messages, the audio data is output by the filter and processing stage 32, via D/A converter 42 and amplifier 44 to an earphone or speaker 46. Receipt of such messages from the telephone network 48 is indicated by arrow 50: the telephone network 48 also provides the link from the telephone 10 to a wide-area network (WAN) server 52 and, via the WAN 54 (which may be the internet), to one or more remote service providers 56 providing a source of data for the telephone 10.

The mobile device of the described embodiment also has a microphone 58, an analogue/digital converter 60, a processor 62, a universal interface protocol UIP 64 and an encoder 28 for transmitting voice signals through the cellular or local networks. Although these features are conventionally provided in mobile devices such as mobile telephones, it will be appreciated that they are not essential for carrying out the invention.

A strong candidate technology for the local link 60 necessary for the present invention is Bluetooth, on the grounds that it is expected to become a component part of a large number of mobile telephones and other mobile devices. In analyzing the Bluetooth protocol, a problem may be seen, especially for the method of the third embodiment described above. In the third embodiment, the mobile device 20 should detect fixed beacons 2 and extract basic information from them without the mobile device 20 needing to transmit at all. However, this type of broadcast operation is not supported by the current Bluetooth specification.

In part, the incompatibility follows the frequency hopping nature of Bluetooth beacon systems which means that, in order for broadcast messages (or, indeed, any messages) to be received by a passing terminal, the terminal has to be synchronized to the beacon in both time and frequency. The portable device 20 has to synchronize its clock to the beacon clock and, from the beacons identity, deduce which of several hopping sequences is being employed.

To make this deduction, the portable device has conventionally been required to join—as a slave—the piconet administered by the beacon as piconet master. Two sets of procedures are used, namely “inquiry” and “page”. Inquiry allows a would-be slave to find a base station and issue a request to join the piconet. Page allows a base station to invite slaves of its choice to join the net. Analysis of these procedures indicates that the time taken to join a piconet and then be in a position to receive information from the master could be several tens of seconds.

Such a Bluetooth procedure according to the standard is suitable for forming the two-way connection envisaged in the first and second embodiments.

An alternative approach is for the mobile device to enter the Bluetooth parked mode. In this mode, the mobile device is given a special identity by the beacon, and sleeps for much of the time, waking up periodically to resynchronize itself to the master and to listen to special beacon messages for possible instructions, including page messages. Again, this mode is particularly suitable for use with the first and second embodiments of the invention and the mode allows 254 mobile devices to be connected at one time instead of the limit of 8 mobile devices in a piconet.

The difficulty of receiving broadcast data from beacons is caused at least partially by the frequency-hopping nature of Bluetooth and similar systems. The Bluetooth inquiry procedure has been proposed specifically to solve the problem of bringing together master and slave: the applicants have recognized that it is possible to piggy-back a broadcast channel on the inquiry messages issued by the master. Only adapted terminals need read the broadcast channel messages, the mechanism is entirely compatible with conventional Bluetooth systems.

To illustrate how it is possible to implement the procedures required for the third embodiment, we first consider how the Inquiry procedures themselves operate, with reference to FIG. 6. When a Bluetooth unit wants to discover other Bluetooth devices, it enters a so-called inquiry substate. In this mode, it issues an inquiry message containing a General Inquiry Access Code (GIAC) or a number of optional Dedicated Inquiry Access Codes (DIAC). This message transmission is repeated at several levels; first, it is transmitted on 16 frequencies from a total of 32 making up the inquiry hopping sequence. The message is sent twice on two frequencies in even timeslots with the following, odd timeslots used to listen for replies on the two corresponding inquiry response hopping frequencies. Sixteen frequencies and their response counterparts can therefore be covered in 16 timeslots, or 10 ms. The chart of FIG. 6 illustrates the transmission sequence on sixteen frequencies centered around f{k}, where f{k} represents the inquiry hopping sequence.

The next step is the repetition of the transmission sequence at least N_{inquiry} times. At the very least, this should be set at N_{inquiry}=256 repetitions of the entire sequence which constitutes a train of transmissions which we refer to as inquiry transmission train A. Next, inquiry transmission train A is swapped for inquiry transmission train B consisting of a transmission sequence on the remaining 16 frequencies. Again, the train B is made up of 256 repetitions of the transmission sequence. Overall, the inquiry transmission cycle between transmissions of train A and train B. The Bluetooth specification states that this switch between trains must occur at least three times to ensure the collection of all responses in an error-free environment. This means that an inquiry broadcast could take at least 10.24 seconds.

One way to reduce this would be for the switch between inquiry transmission trains to be made more rapidly, i.e. without waiting until the 2.56 seconds for 256 repetitions of the 10 ms to cover the 16 timeslots is up. This may suitably be accomplished by setting the systems to switch over if no inquiry message is detected after approximately 50 ms, on the understanding that no such message will be detected in the remainder of the present train.

In a conventional approach, a portable device that wants to be discovered by a beacon enters the inquiry scan substate. Here, it listens for a message containing the GIAC or DIAC's of interest. It, too, operates in a cyclic way. It listens on a single hop frequency for an inquiry scan period which must be long enough to cover the 16 inquiry frequencies used by the inquiry. The interval between the beginning of successive scans must be no greater than 1.28 seconds. The frequency chosen comes from the list of 32 making up the inquiry hopping sequence.

On hearing an inquiry containing an appropriate IAC, the portable device enters a so-called inquiry response substate and issues a number of inquiry response messages to the beacon. The beacon will then page the portable device, inviting it to join the piconet.

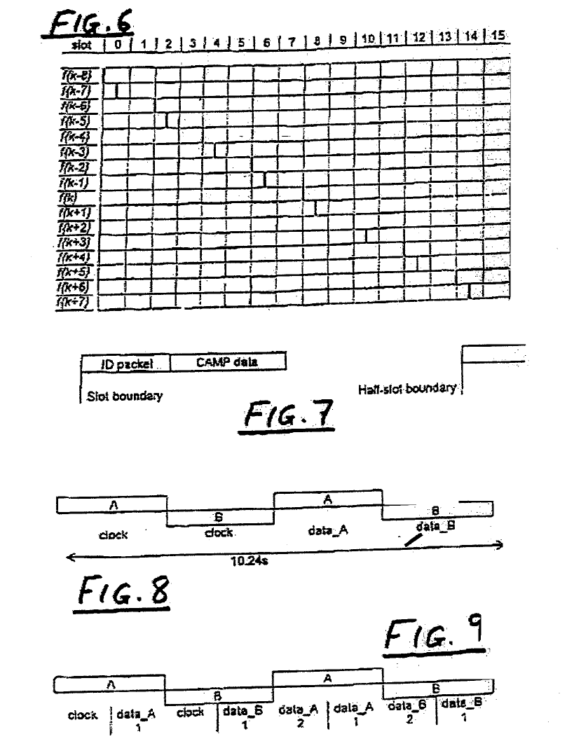

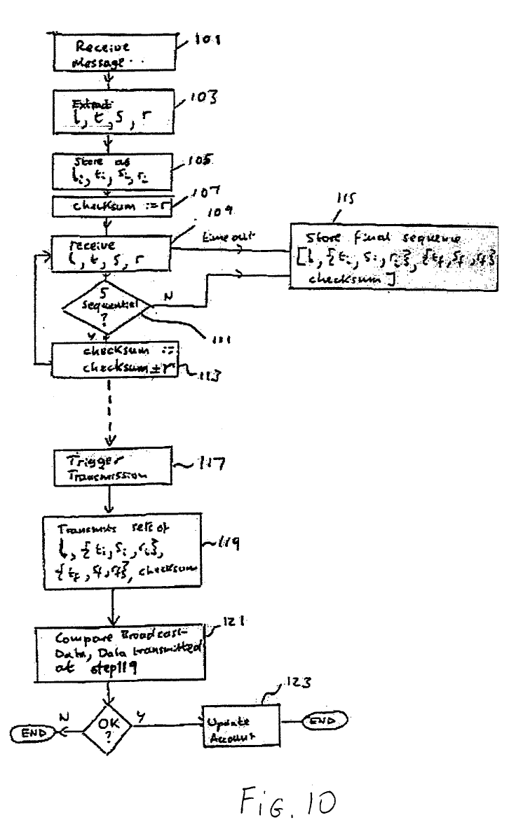

As shown in FIG. 7, the applicants propose that the inquiry messages issued by the beacon have an extra field appended to them, capable of carrying data. By adding the field to the end of the inquiry message, it will be appreciated that non-adapted receivers can ignore it without modification.

The presence of the extra data field means that the guard space conventionally allowed at the end of a Bluetooth inquiry packet is reduced. However, this space—provided to give a frequency synthesizer time to change to a new hop frequency—will be generally unused otherwise, as current frequency synthesizers are capable of switching at speeds which do not need extension into the extra guard space. The standard inquiry packet is an ID packet of length 68 bits. Since it is sent in a half-slot, the guard space allocated is (625/2−68)=244.5 μs (625 μs slot period, 1 Mbit/s signaling rate). Modern synthesizers can switch in much less time with figures of 100 μs or lower considered routine by experts in the field. Applicants therefore propose allocation of 100 bits as a suitable size for this new field, although it will be readily understood that other field sizes are, of course, possible.

Mobile devices can receive the broadcast data quickly without being required to run through a lengthy procedure to join a piconet. In addition, since there is no need for the handset to transmit any information whatsoever, there is a consequent power saving that will be particularly important in dense environments where many base stations may be present. Nevertheless, when the handset is in interactive mode and wishes to join a piconet in order to obtain more information, it may employ the default inquiry procedures as normal. There is no loss of functionality through supporting the additional data field.

In a typical embodiment, four of our 100 bits will be lost as trailer bits for the ID field; this is a consequence of it being read by a correlator. Of the 96 bits remaining, applicants preferred allocation is that 64 be used as data and 32 as a ⅔ FEC (forward error correction) checksum. Each inquiry burst thus contains 8 bytes of broadcast data. In a most common scenario, by the second group of A and B trains the portable device has found the base station, understood it to be transmitting extra data beacon and is awaiting the broadcast data. Since it will be listening specifically, the portable device will at least be able to read 256 bursts of data twice (A and B), giving us two lots of 2 Kbytes, or 4 Kbytes in total.

At this stage, the portable device does not know the phase of the beacons clock because this information is not been transmitted. To assist the portable device, clock information is transmitted in at least some of the trains in the first A and B groups, as shown in FIG. 8, together with some auxiliary information indicating when the next switches between A and B will occur. This clock information will be transmitted in place of the broadcast data so means are provided to discriminate between the two data channels. Use of separate DIAC's is one possible method.

In the case where the portable device knows the timing of the beacon, the portable device also knows how it will hop, which gives the ability to track all transmissions of a train. Since there are 16 transmissions in a frame, then the resultant channel has 16 times as much capacity and can convey 64 Kbytes of information.

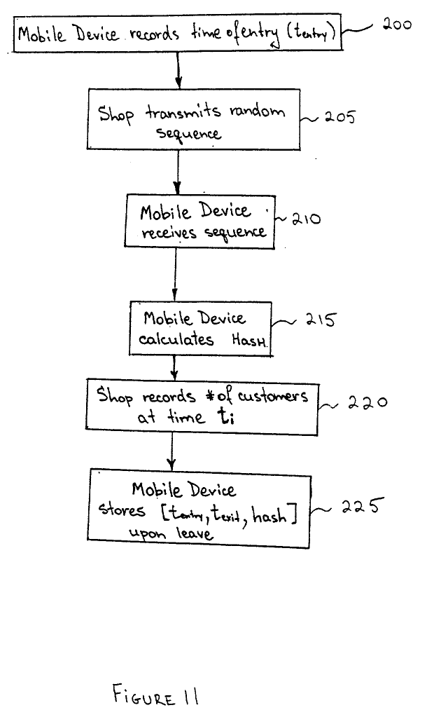

Since the terminal wakes up every 1.28 seconds or less, it will generally have obtained the clocking information it needs by the half-way mark in the first A or B periods. Switching from clock to data at these halfway marks, as illustrated in FIG. 9, provides a number of useful advantages. Firstly, some data can be received in less than five seconds from the start of the inquiry procedure. Secondly, the terminal can still respond to an important key by automatically issuing an inquiry response message to the base station (if that is the appropriate action for the terminal to take) even if the key appears comparatively late in the cycle. It will be noted that no increase in capacity is assumed.

In the foregoing, a portable device will receive all the additional data field packets on one of the 32 inquiry channels, thereby using only 1/32 of the available bandwidth. As will be recognized, if the uncertainty as to when a portable terminal (beacon slave) receives the first inquiry packet can be overcome, the predetermined nature of the hopping sequence may be accommodated and the full bandwidth therefore utilized. For a slave to synchronize with a master's inquiry hopping sequence from the point where it received the first packet, the slave needs to know both—the masters clock offset and the position of the first received packet in the masters hopping sequence.

An alternative method of synchronizing the slave hopping is to transmit clocking data in every broadcast field. The additional data field (BCD; FIG. 5) carries 4 bytes containing the following information:

Master clock offset (2 bytes);

Number of full train repetitions (1 byte)—assuming that a full train consists of 256 repetitions of 10 ms trains, the range of this parameter is 0-255 (before the inquiry switches to the next full train). This indicates to the slave when the master will next switch the full train.

How many full train switches have been completed in the current inquiry cycle (1 byte)—this data indicates to the slave what the master is likely to do at the end of the current full train, i.e. whether it will switch over to another full train or whether the inquiry procedure will terminate.

As long as no channel repeats in the 10 ms train, no field is required to indicate the position of the current channel in the hopping sequence as the slave is able to derive this from knowledge of the sequence.

From the foregoing it will be seen that, by adding 4 bytes to each additional field packet, the slave can then pick up all additional field packets to the end of the inquiry, while still having 4 bytes available (from our preferred assignment of 64 from 100 bits for data) to carry broadcast data.

If 4 bytes does not suffice to transmit the sequence data then the data can be subdivided into 4-byte portions each sent out with subsequent data packets.

The transmission of broadcast sequences may occur only at certain times. These may be remotely triggered, for example by a TV broadcast, radio, cellular phone, over the internet, etc.

Rather than generate the credit/debit broadcasts as they are transmitted, they may be stored and then broadcast when triggered to do so.

A first example of this is that TV channels, audio CD's, video game CD-ROMs, downloaded MP3 music might trigger credit broadcasting from R.F. (Radio Frequency) or I.R. (Infra Red) beacons, which have been embedded in the consumers' home appliances, such as TV set-top-boxes, audio equipment, radio or TV's. These might broadcast credits, or coupons to those mobile phones which are within the beacon's vicinity in the home.

The data set (random sequence) for credit validation might be pre-cached in the home CE device and just triggered by the TV broadcaster or it might send, embedded in the real-time (digital) TV signal stream into beneficiaries' homes. A cable company or service, that knows to which channel a consumer's set is tuned in, might in this way broadcast credits to the watchers of all, or a part of, a particular TV show, or they might credit consumers in their living rooms who tune into a particular TV advert.

In an extension, a local storage device (hard disc, VCR) might store both TV program and linked credits for a subsequent viewing and R.F. credit broadcast. The broadcasting of a stored credit sequence might be done by a Java program applet for which its activation causes it to delete itself to prevent re-use, or other methods used as detailed previously to counter fraudulent multiple submissions of identical sequences for credit by the same person/device.

A second example is a CD-ROM game which might contain a reward/penalty system for crediting/debiting a player's mobile phone, within R.F. beacon range of the game machine, when a certain level of the game is reached. Such a CD-ROM might itself contain the credit data sets to be broadcast over R.F., or these might be stored in the game machine and just triggered by the CD-ROM game, or the data sets might be retrieved from the Internet if the game machine is web-enabled. The game may be arranged, for example, so that only on the first time that a player reached the rewarding game level, did the broadcast of the R.F. credit sequence get triggered with this CD-ROM copy.

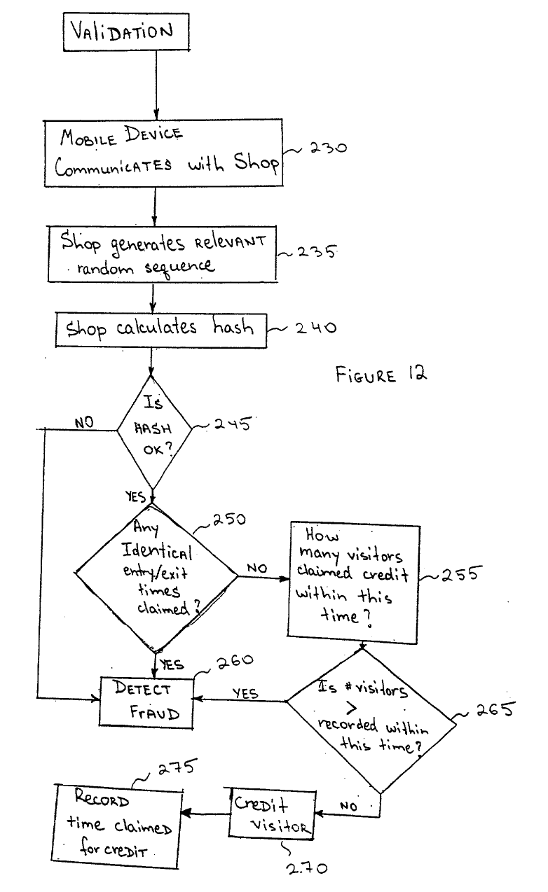

FIG. 11 illustrates a fourth embodiment of the present invention. In accordance with the invention, the method of the fourth embodiment includes detecting time of entry of the user to a locale and upon entry into the locale, such as a shop, the portable or mobile device 20 detects the awarding system and the time of entry (t_{entry}) is stored within the device's memory (step 200). A source, such as a beacon within the locale (shop), constantly transmits a pseudorandom bit stream at a very fast rate (step 205). For example, a random bit stream, where blocks of bits form binary numbers can be transmitted at 10 Mbits/second. The bit stream transmitted by the system locale within the shop is transmitted at a sufficiently high rate in order to eliminate cheating by recording the whole stream, i.e. creating other sequences based on the information already collected. The amount of data, if transmitted sufficiently fast, will be too large to be stored in a hand-held device. For example, 1 MByte/sec transmission rate would require 3.6 GByte of information to be stored in a 1 hour long period. This is a significantly large amount of storage space and currently cannot be handled by a mobile device. Conversely, the bit stream should not be transmitted too fast either, otherwise the mobile device would not be able to process the information fast enough, i.e. applying a hash function. In a preferred embodiment, a random seed for the generation of the bit stream can be chosen periodically to increase security as is known in the art.

While the mobile device receives the random sequence (step 210), and further in accordance with the invention, the device calculates a hash value of the newly received random number and one or more previous hash values and potentially other pieces of information such as ID's, time, etc. until the device exits the locale, at which point the final hash value is calculated and stored in the memory of the device. (step 215) Generally, the mobile device continues to calculate hash values for each received bit stream and each previously received bit stream. Additional information, such as time of day and identification numbers can be stored in the memory of the device.

In accordance with the fourth embodiment of the present invention, an iterated hash function is preferred to calculate the hash value. This is because conventional checksum calculation of received data is not typically very secure. That is, conventional checksums can be merged easily by different mobile devices, thus cheating is possible. The sum of two conventional checksums, one directly following the other, form the checksum of the combined interval. Cheating, therefore, can be achieved in the following way. When the second customer arrives at the shop the first one can leave. Later the two customers exchange information by merging their time in the shop, which is known as “merging attack”, so that they both can claim a longer stay and a larger credit than each really earned.

Thus, calculation of a cumulative non-invertible function of the received random number sequence allows greater security. One possibility is a CRC with linear feedback shift registers. In order to avoid merging attack possibility, the calculated hash value therefore will depend on all or a substantial amount of the previous information and not just the last calculated value. An example of an iterated hash function is provided for purpose of example, but not limitation:

The initial hash value is h₀=H(t₀,ID), where H is the hash function, to is the entry time and ID is the user identification number such as a phone number). The initial hash value is stored in the device for later use.

Each hash value is calculated when a new random number is received, from the previous hash values and the newly received random number transmitted by the equipment of the locale as follows:

h₁=H(r₁,h₀), . . . , hᵢ=H(rᵢ,hᵢ₋₁),

Therefore, if the hi value of one device is given to a second device, the second device will continue generating a hash sequence, but this sequence will not originate from the identification (ID′) of the second device, which starts the sequence with h′₀=H(t′₀,ID′). Any kind of cheating based on transferring either hash values or internal calculation states would therefore be impossible.

In accordance with another aspect of the present invention, at any particular time (tᵢ), the locale also can determine and store the number of customers present at that time (step 220). In an array of data indexed by the time for each day, the actual number of customers in the shop at the corresponding time can be stored. When a bonus is redeemed, the array values corresponding to the number of customers in the store at the claimed time will be decreased by one. If any one of the array elements decreases below zero, the shop detects fraud. This procedure, therefore, can minimize the number of illicit duplicate credit claims. Alternatively, the procedure of counting the intersections of the claimed intervals may be achieved by implementing other algorithms well known in the art. For example, with interval coloring algorithm, the time points are colored with different scales of dark gray, proportional to the number of people. When credits are redeemed, the array values corresponding to the claimed time are decreased by one, i.e. colored with a slightly lighter gray. If any of the array elements decreases below zero, i.e. reaches white color, the shop will detect fraud.

Further in accordance with the present invention, the time of exit of the user from the locale is detected. Upon exit, the mobile device preferably records at least three pieces of information: time of entry, time of exit and the final hash value (step 225). Similarly, in a database associated with the locale, similar information can be recorded. Any conventional memory can be used.

The present invention also includes the steps of verifying the time of entry, time of exit, the final hash value, and granting point for the user based on the verified time at the locale. The validation or verification procedure, as illustrated in FIG. 12, will be discussed below.

To claim credit for a certain amount of time spent in a shop, a user will communicate with the shop's validation system using his/her mobile device (step 230). The validation system of the shop checks the validity of the claim by first generating the relevant portion of the pseudo random sequence sent by the shop during the user's time of stay (step 235). At step 240 the system calculates the hash value for the generated sequence starting with H(t₀,ID), the hash of the claimed entry time and the user's ID and compares it to the hash value stored in the mobile device (step 245). Alternatively, the calculated hash value can be stored in the database of the shop at the time of exit of the customer. If the hash values are not substantially equal, the system will detect fraud and the user will not be credited (step 260). Because the time base of the shop and that of the user's device may not be synchronous, although they should be reasonably close, the shop can be configured to calculate the time based offset or attempt to enter a few different time offset values.

Another possible security feature to detect fraud in accordance with the invention involves the system recording the time of entry and exit for every redeemed credit claim. This feature eliminates duplication of credit claims. For example, if the time resolution is sufficiently high to distinguish between separate customers entering or exiting the shop at a given time, i.e. within milliseconds, the probability of a collision or overlap of the customers' entry and exit times is very small. Preferably, a limit can be set for the number of customers that can enter the shop at a given time, such as by using turnstiles or gates. The limit would correspond to the time resolution of the system. A central clock can be used to synchronize the time between the shop and the mobile device. If the mobile device has a built in clock, a little error can be tolerated. Therefore, a limit can be set for a maximum number of collisions from which the system will start the countdown to detect fraud. Thus, at step 250, the system, assuming the limit is set to zero, will look for substantially identical entry/exit times already claimed. If identical times exist, the system detects fraud (step 260).

Moreover, the validation system can keep track of the number of customers present at any given time in the shop. This number can be recorded in the system's central database and later used for verification purposes. The system, during the validation procedure, will keep a counter of the number of visitors who have redeemed credits within a certain time range (255). Upon validation of each claim, the system will compare this number to the number of visitors previously recorded within that time range present in the shop (step 265). The counter is periodically reduced for every claim within the claimed time period. However, if the counter goes below zero, i.e. the number of visitors claiming credits within time period T is greater than the number of visitors recorded to be present in the store within the time period T, the system will detect fraud.

If the validation system does not detect fraud, the user is granted points based upon the verified time at the locale. For example, if the counter is greater or equal to zero, the visitor is credited at step 270, and the time period redeemed is recorded for future verification purposes (step 275).

Although the specific embodiments of the invention have been described above, the invention is not limited to these embodiments. In particular, although the embodiments have been described with reference to Bluetooth communications, the invention is not limited to Bluetooth and any communications protocol may be used, including, for example, irDA, or 802.11.

Furthermore, other applications may include broadcasting credits to recompense people in a place. This may be particularly useful for delayed train and rail passengers or airline passengers. The credit may be a discount for future fares or may be exchangeable for goods and services in the locale, for example food and drink.

Another application may be to credit workers with rewards for remaining late at work, for example monetary rewards or food or entertainment credit.

Although the specific embodiments of the invention have been described with reference to positive points or rewards, the invention may also be extended to include negative points or debits. For example, the invention could be used to charge users for presence within a locale, such as admission fee, or to discourage users from remaining in certain locales, for example to incite people to move away from an overcrowded location. Such a system may be useful, for example, in games or mazes in entertainment locales to charge users for their presence in the locale.

The methods and systems of the present invention, as described above and shown in the drawings, provide for customers' reward and debit based on the time spent in a locale.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

What is claimed is:

1. A method of granting points to a user for time in a locale, the method comprising the steps of:
detecting time of entry of the user to the locale;
transmitting at least one pseudo random bit stream to a portable device associated with the user, the bit stream being transmitted at a rate sufficient to prevent the bit stream from being recorded by the portable device;
calculating a hash value for the bit stream transmitted to the portable device;
detecting time of exit of the user from the locale;
recording information in a memory of the portable device, the recorded information including at least the calculated hash value, the time of entry and the time of exit;
storing data in a database associated with the locale, the stored data including enough information to re-generate the bit stream at any time interval and the number of customers in the locale at any time;
verifying time of the user at the locale by comparing the stored information and the recorded data; and
granting points for the user based on the verified time at the locale.

2. The method of claim 1, wherein the transmitting step includes at least periodically using a random seed for bit stream creation.

3. The method of claim 1, wherein the transmitting step includes transmitting a plurality of pseudo random bit streams; and further wherein the calculating step is performed using an iterated hash function to calculate the hash value of the plurality of the bits in the transmitted streams.

4. The method of claim 1, wherein the storing step includes indexing the stored data by time of day and by the date.

5. The method of claim 1, further including the step of determining the number of users at the locale at any given time; the storing step including storing as stored data the number of users determined to be at the locale; and further wherein the verifying step includes ensuring that points are not granted to more users than the number of users determined to be at the locale for the given time.

6. The method of claim 1, wherein each detecting step is capable of distinguishing between two separate users at a given time; and further wherein the verifying step includes ensuring that points are not granted when each user cannot be distinguished for the given time.

7. The method of claim 1, wherein the points granted by the granting step are positive rewards.

8. A system of granting points to a user for time in a locale, the system comprising:
a portable device associated with the user, the portable device having a calculator for calculating a hash value of a bit stream, and a memory for recording information; and
a verification system for verifying time of the user at the locale, the verification system including
means for verifying requested time of entry of the user to the locale and time of exit of the user from the locale,
a source for transmitting at least one pseudo random bit stream to the portable device, the bit stream being transmitted at a rate sufficient to prevent the bit stream from being recorded by the portable device,
a calculator for calculating the hash value of the bit stream,
a database for storing data, such as random number generator seeds and their activation time, which allows the calculation of data including at least the hash value of the bit stream between any time of entry and time of exit,
means for comparing the generated values based on the stored data from the database and the recorded information from the portable device, wherein the recorded information includes at least the calculated hash value, the time of entry and the time of exit, to verify time of the user at the locale, and
means for granting points to the user based on the verified time at the locale.

9. The system of claim 8, wherein the source periodically using a random seed for bit stream creation.

10. The system of claim 8, wherein the source transmits a plurality of pseudo random bit streams; and further wherein the calculator uses an iterated hash function to calculate the hash value of a plurality of bits from bit streams.

11. The system of claim 8 further including means for determining the number of users at the locale at any given time; and means for ensuring that points are not granted to more users than the number of users determined to be at the locale for the given time.

12. The system of claim 8, wherein the detecting means is capable of distinguishing between two separate users at a given time; and further wherein the verification system includes means for ensuring that points are not granted when each user cannot be distinguished for the given time.

13. A method of granting points to a user for time in a locale, the method comprising the steps of:
detecting time of entry of the user to the locale;
transmitting pseudo random bit streams to a portable device associated with the user, the bit streams constantly being transmitted at a rate sufficient to prevent the bit stream from being recorded by the portable device;
calculating a hash value for the bit streams transmitted to the portable device using an iterated hash function;
detecting time of exit of the user from the locale;
recording information in a memory of the portable device, the recorded information including at least the time of entry, the time of exit, the calculated hash value between the time of entry and the time of exit;
storing data in a database associated with the locale, the stored data including enough information, such as the seed values and their activation time, which allows generating the hash value of the bit stream between any time of entry and time of exit;
verifying time of the user at the locale by comparing newly generated data based on the stored information and claimed entry and exit times and the recorded data of the mobile device; and
granting points for the user based on the verified time at the locale.

14. The method of claim 13, further including the step of determining the number of users at the locale at any given time, the storing step further including storing as stored data the number of users determined to be at the locale; and further wherein the verifying step includes ensuring that points are not granted to more users than the number of users determined to be at the locale for any part of the given time.

15. The method of claim 13, wherein each detecting step is capable of distinguishing between two separate users at a given time; and further wherein the verifying step includes ensuring that points are not granted when each user cannot be distinguished for the given time.
